(19) United States
(12) Patent Application Publication
(10) Pub. No.: US 2026/0044961 A1
(43) Pub. Date: Feb. 12, 2026

(54) DEEP LEARNING-ENABLED AUTOMATED DETECTION AND MEASUREMENT SYSTEM FOR ANTI-CORROSION PROPERTIES OF COATINGS

(71) Applicant: DOW GLOBAL TECHNOLOGIES LLC, Midland, MI (US)

(72) Inventors: Yang LIU, Shanghai (CN); Yongjin GUO, Shanghai (CN); Matthew Nicholas BENEDICT, Easton, PA (US); Yan WU, Shanghai (CN); Yi ZHANG, Shanghai (CN); Bin CHEN, Shanghai (CN); Hua HUANG, Shanghai (CN)

(21) Appl. No.: 19/103,067

(22) PCT Filed: Sep. 28, 2022
(86) PCT No.: PCT/CN2022/122182

§ 371 Date: Feb. 11, 2025

(51) Int. Cl. G06T 7/11; G06T 7/00; G06T 7/174

(52) U.S. Cl. CPC G06T 7/11; G06T 7/0004; G06T 7/174; G06T 2207/10016; G06T 2207/10024; G06T 2207/10152; G06T 2207/20081; G06T 2207/20084

(57) ABSTRACT

A system for evaluation anti-corrosion properties of a coating when applied on a corrosion susceptible substrate, containing: (i) an imaging unit configured to capture a plurality of grayscale images of the coating; (ii) a computational image processing unit configured to receive and reconstruct the captured plurality of grayscale images and to output a reconstructed topographic image and a reconstructed color image; (iii) a data pre-processing unit configured to receive and combine the reconstructed topographic image and the reconstructed color image and to output images containing high-dimensional data that comprises one-dimensional height data and at least three-dimensional color data; (iv) a corrosion detection unit configured to receive the high-dimensional data and recognize corrosion features and to output at least locations, classifications, and regions of the corrosion features; where the corrosion detection unit comprises a corrosion detection neural network having ai, input layer and an output layer, where ai, input data to the input layer contains the high-dimension data and an output data from the output layer contains at least locations, classification, and regions of the corrosion features; and (v) a computer-aided data analysis unit configured to receive and analyze the data containing at least location, classifications, and regions of the corrosion feature is and to output predicted ratings of corrosion severity; a computer-implemented method of evaluation of anti-corrosion properties of a coating when applied on a corrosion susceptible substrate; a computing device with a computational image processing unit, a data pre-processing unit, a corrosion detection unit, and a computer-aided data analysis unit, deployed thereon; and a process for training neural network for detection corrosion.

### FIELD

The present invention relates to a deep learning-enabled automated detection and measurement system for corrosion failures, particularly suitable for automatically detection and quantified evaluation of anti-corrosion properties of protective coatings.

### INTRODUCTION

Steel corrosion causes a huge loss to the global economy and is a basic infrastructure challenge. Protective coatings are widely used to prevent corrosion. Numbers of protective coatings are provided to cover different anti-corrosion requirements spanning from light industrial uses to heavy duty applications. This posts the challenge on how to quantify anti-corrosion properties of protective coatings. Anti-corrosion properties of coatings are usually evaluated by first exposing coated panels to a salt fog according to ASTM B117-11 salt spray test to mimic corrosive environments, and then visually inspecting and rating corrosion failures by operators. For example, defects of rusting and blistering are rated by comparing with standard patterns defined in ASTM D610-08 and ASTM D714-02, respectively, and creepage defects are measured in millimeter according to ASTM D1654-08. Moreover, such visual inspection and rating work conducted by human is laborious and time consuming, which also tends to be subjective. Interference of flow of a salt solution used in the salt spray test (also known as “rust bleed” or staining), and insensitivity of human eyes to capture tiny blisters and identify their distribution also make test results of anti-corrosion properties error-prone.

Sone imaging and machine vision systems and methods have been proposed for detection of corrosion defects using color digital camera imaging. However, none is directed to an autonomous and standardized process for detecting corrosion features and rating anti-corrosion properties of coatings when applied on a metal substrate subjected to corrosive environments such as salt spraying. It is therefore desirable to provide a system and method of automated detection and quantified evaluation of anti-corrosion properties of coatings when applied on a corrosion susceptible substrate using deep learning.

### SUMMARY

The present invention provides a novel system and method by means of intelligent detection and automatic imaging analysis to quantify corrosion failures of coating when applied on a corrosion susceptible substrate (hereinafter “coated metal panels” or “coated panels”) in the standardized ASTM B117-11 salt spray test, by adopting a novel combination of computational imaging techniques, a deep learning neural network, and computer-aided data analysis. The system of the present invention also enables a standardized approach to detect and quantify anti-corrosion properties of coatings on coated metal panels. The predicted ratings of corrosion severity of the present invention have been validated by the correlation with human rated results, which enables an autonomous process to predict accurate and reliable ratings of corrosion severity as compared to actual results obtained by visual inspection and ratings by human. The method of the present invention can effectively mitigate the interference of rust bleed on the surface caused by the flow of a salt solution. The system of the present invention can also distinguish minor differences between different corrosion features that cannot be differentiated by human through visual inspection, such as rusting and blistering. The method of the present invention can also greatly improve test consistency and accuracy and reduce labor costs.

In a first aspect, the present invention is a system for evaluation of anti-corrosion properties of a coating when applied on a corrosion susceptible substrate, comprising:
(i) an imaging unit configured to capture a plurality of gray scale images of the coating;
(ii) a computational image processing unit configured to receive and reconstruct the captured plurality of grayscale images and to output a reconstructed topographic image and a reconstructed color image;
(iii) a data preprocessing unit configured to receive and combine the reconstructed topographic image and the reconstructed color image and to output images containing high-dimensional data that comprises one-dimensional height data and at least three-dimensional color data;
(iv) a corrosion detection unit configured to receive the high-dimensional data and recognize corrosion features and to output at least locations, classifications, and regions of the corrosion features: wherein the corrosion detection unit comprises a corrosion detection neural network having an input layer and an output layer, wherein an input data to the input layer contains the high-dimensional data and an output data from the output layer contains at least locations, classifications, and regions of the corrosion features; and
(v) a computer-aided data analysis unit configured to receive and analyze the data containing at least locations, classifications, and regions of the corrosion features and to output predicted ratings of corrosion severity.

In a second aspect, the present invention is a computer-implemented method of evaluation of anti-corrosion properties of a coating when applied on a corrosion susceptible substrate. The method comprises:
receiving a plurality of grayscale images of the coating;
reconstructing the plurality of grayscale images by computational image processing and outputting a reconstructed topographic image and a reconstructed color image;
combining the reconstructed topographic image and the reconstructed color image into images containing high-dimensional data comprising one-dimensional height data and at least three-dimensional color data;
inputting the high-dimensional data to a corrosion detection unit configured to recognize corrosion features and to output at least locations, classifications, and regions of the corrosion features, wherein the corrosion detection unit comprises a corrosion detection neural network having an input layer receiving an input data and an output layer outputting an output data, wherein the input data contains the high-dimensional data and the output data contains at least locations, classifications, and regions of the corrosion features; and receiving and analyzing the data containing at least locations, classifications, and regions of the corrosion features and outputting predicted ratings of corrosion severity by computer-aided data analysis.

In a third aspect, the present invention is a computing device with a computational image processing unit, a data preprocessing unit, a corrosion detection unit, and a computer-aided data analysis unit, deployed thereon;
wherein the computational image processing unit is configured to receive and reconstruct the captured plurality of grayscale images and to output a reconstructed topographic image and a reconstructed color image;
wherein the data preprocessing unit is configured to receive and combine the reconstructed topographic image and the reconstructed color image and to output images containing high-dimensional data that comprises one-dimensional height data and at least three-dimensional color data;
wherein the corrosion detection unit is configured to receive the high-dimensional data and recognize corrosion features and to output at least locations, classifications, and regions of the corrosion features, wherein the corrosion detection unit comprises a corrosion detection neural network having an input layer and an output layer, wherein an input data to the input layer contains the high-dimensional data and an output data from the output layer contains at least locations, classifications, and regions of the corrosion features; and
wherein the computer-aided data analysis unit is configured to receive and analyze the data containing at least locations, classifications, and regions of the corrosion features and to output predicted ratings of corrosion severity.

In a fourth aspect, the present invention is a process for training a neural network for detection corrosion. The process comprises:
collecting a plurality of grayscale images of a set of coatings when applied on a corrosion susceptible substrate;
reconstructing the captured grayscale images for each coating by computational processing and outputting a reconstructed topographic image and a reconstructed color image for each coating;
combining the reconstructed topographic image and the reconstructed color image for each coating and outputting images containing high-dimensional data for each coating, comprising one-dimensional height data and at least three-dimensional color data;
obtaining at least actual locations, classifications, and regions of corrosion features for each coating identified according to a quantified degree of rusting, degree of blistering, and maximum creepage;
creating a training dataset comprising a set of the high-dimensional data and a set of data containing the at least actual locations, classifications, and regions of corrosion features for the set of coatings; and
training the neural network using the training dataset; thereby obtaining the trained neural network.

### BRIEF DESCRIPTION OF THE DRAWINGS

FIG. 1 illustrates a schematic diagram of a system for evaluation of anti-corrosion properties of a coating when applied on a corrosion susceptible substrate.

FIG. 2 illustrates a flow chart of a method of evaluating anti-corrosion properties of a coating on a corrosion susceptible substrate in accordance with one example of the present invention.

FIG. 3 illustrates a schematic illustration of a multi-angle illumination imaging device in accordance with one example of the present invention.

FIG. 4 illustrates a schematic illustration of a multispectral illumination imaging device in accordance with one example of the present invention.

FIG. 5 is a schematic illustration of the principle of shape-from-shading algorithm.

FIG. 6 illustrates a schematic flowchart for obtaining a topographic image from the multi-angle illumination images of a coated metal panel according to one example of the present invention.

FIG. 7 illustrates a schematic diagram of color image reconstruction from multiple single-wavelength-illumination images.

FIG. 8 illustrates a computational color image reconstructed from images of a coated metal panel captured by a multispectral illumination imaging device in accordance with one example of the present invention.

FIG. 9 illustrates a schematic diagram of high-dimensional data combined from the outputs of the computational image processing unit in accordance with one example of the present invention.

FIG. 10 illustrates a schematic diagram of a typical U-Net neural network.

FIG. 11 illustrates a model training process for a deep learning neural network in accordance with one example of the present invention.

FIG. 12 illustrates a schematic flowchart of a one-step deep learning neural network for corrosion recognition and classification in accordance with one example of the present invention.

FIG. 13 illustrates a schematic flowchart of a two-step deep learning neural network for corrosion recognition and classification in accordance with one example of the present invention.

FIG. 14 illustrates an example of creepage calculation in accordance with one example of the present invention.

FIG. 15 illustrates an exemplary process for rating rusting on a coated metal panel in accordance with one example of the present invention.

FIG. 16 illustrates an exemplary process for rating rusting on a coated metal panel in accordance with one example of the present invention.

FIG. 17 illustrates a final output image from the inventive system in accordance with one example of the present invention.

FIG. 18 illustrates a schematic drawing of a cloud-based server cluster in accordance with one example of the present invention.

FIG. 19 illustrates correlation results for white paint coated metal panels evaluated by manual evaluation and inventive system in accordance with Example 1.

FIG. 20 illustrates correlation results for gray paint coated metal panels evaluated by manual evaluation and inventive system in accordance with Example 2.

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods.

“Neural network” refers to an artificial neural network composed of artificial neurons or nodes and used for solving artificial intelligence (AI) problems. The connections of the biological neuron are modeled in artificial neural networks as weights between nodes. A positive weight reflects an excitatory connection, while negative values mean inhibitory connections. All inputs are modified by a weight and summed. This activity is referred to as a linear combination. Finally, an activation function controls the amplitude of the output.

“Machine learning” refers to a set of methods that ‘learn’ from data to improve performance on specific tasks. Machine learning algorithms build models based on historical data, also known as training data, to make predictions as the model outputs.

“Deep learning” is a type of machine learning in which a model learns to perform classification tasks directly from images, text or sound. Deep learning is usually implemented using neural network architecture. The term“deep” of deep learning refers to the number of layers in the network. The more the layers, the deeper the network. Deep learning may contain three or more layers or even hundreds of layers in the neural network.

“Grayscale” in digital images means that the value of each pixel represents only the intensity information of the light. Grayscale images typically display only the darkest black to the brightest white. In other words, the image contains only black, white, and gray colors, in which gray has multiple levels. In a grayscale image, each pixel has a value between 0 and 255, where zero corresponds to “black” and 255 corresponds to “white”. The values in between 0 and 255 are varying shades of gray, where values closer to 0 are darker and values closer to 255 are lighter.

“Image segmentation” refers to a technique used in digital image processing and analysis to partition an image into multiple parts or regions, often based on the characteristics of pixels in the image.

“Coating” (interchangeable with “coating film”) herein means a film or coating film that is formed by applying a coating composition to a substrate, and drying, or allowing to dry, the coating composition.

“Coated metal panel” (interchangeable with “coated panel”) herein refers to a coating coated on a corrosion susceptible substrate. “Corrosion susceptible substrate” refers to a substrate susceptible to corrosion, such as a metal substate, desirably, a steel substrate.

Images of a coating, a coating sample, or a coated panel refer to the images of the surface of the coating, the coating sample, or coated panel which a coating has been applied to.

“Anti-corrosion properties” of a coating are typically characterized by one or more corrosion features.

“Corrosion features” (interchangeable with “corrosion defects”) of a coating means characteristics of the coating's defects caused by corrosion of a corrosion susceptible substrate which the coating is applied to. Corrosion features may include features that are useful for rating corrosion severity, including location, type (i.e., classification), size (e.g., length and/or width), number, density (e.g., distribution), of the defects. Classifications of corrosion features or corrosion defects herein include rusting defects, blistering defects, creepage, or combinations thereof.

“Ratings of corrosion severity” may include severity of rusting, severity of blistering, maximum creepage, or combinations thereof; particularly, the ratings defined in the below ASTM standards for evaluating corrosion severity for coatings when applied to a corrosion susceptible substrate. For example, severity of rusting is based on quantified degree of rusting, such as in accordance with ASTM D610-08 (Standard practice for evaluating degree of rusting on painted steel surfaces), which may include rust grade identified by size of rusted area (e.g., by percentage of surface area rusted) and type of rust distribution on the coating. Severity of blistering is based on quantified degree of blistering, such as in accordance with ASTM D71442 (Standard test method for evaluating degree of blistering of paints), which may include size and frequency (e.g., density) of blisters on the coating. Maximum creepage refers to maximum corroded width in millimeter (mm) from scribe on coated metal panels, for example, in accordance with ASTM D1654-08 (Standard test method for evaluation of painted or coated specimens subjected to corrosive environments).

The present invention can realize fully automated evaluation of anti-corrosion properties of coatings when applied to a corrosion susceptible substrate (hereinafter “coated metal panels”) in accordance with ASTM standards through the combination of a variety of hardware and algorithms. The present invention can greatly improve the shortcomings associated with manual evaluations such as the accuracy and time-consuming issues. Surfaces of the coated metal panels after exposure to corrosive environments such as a salt spray have three-dimensional surface structure but little to no contrast and visually noisy, particularly, initiation of corrosion on coated metal panels is difficult to detect by visual inspection. Comparing with conventional machine vision systems for corrosion detection which directly use images acquired by conventional digital color cameras as the input for machine learning, the present invention, by using computational imaging processing of grayscale images to accurately reconstruct coatings' surface defects caused by corrosion, can acquire more precise surface height map and color information with higher discrimination at the stage of data collection, which are essential to subsequent recognition and quantified analysis of corrosion features. The resulting reconstructed topographic and color images are combined into images containing high-dimensional data. Using such high-dimensional data as the input for training a corrosion detection neural network can improve the accuracy of detection and recognition of corrosion features, enable the present invention to distinguish actual rusting from rust bleed on a coating surface (thereby mitigating the interference of rust bleed on corrosion ratings), and provide data relating to corrosion features sufficient for quantified ratings of corrosion severity in subsequent computer-aided data analysis. Therefore, the system and method of the present invention enables an autonomous process to detect corrosion defects, even in the early stage of corrosion failures, and to quantitatively rate corrosion severity, which has been validated by the correlation with human rating results.

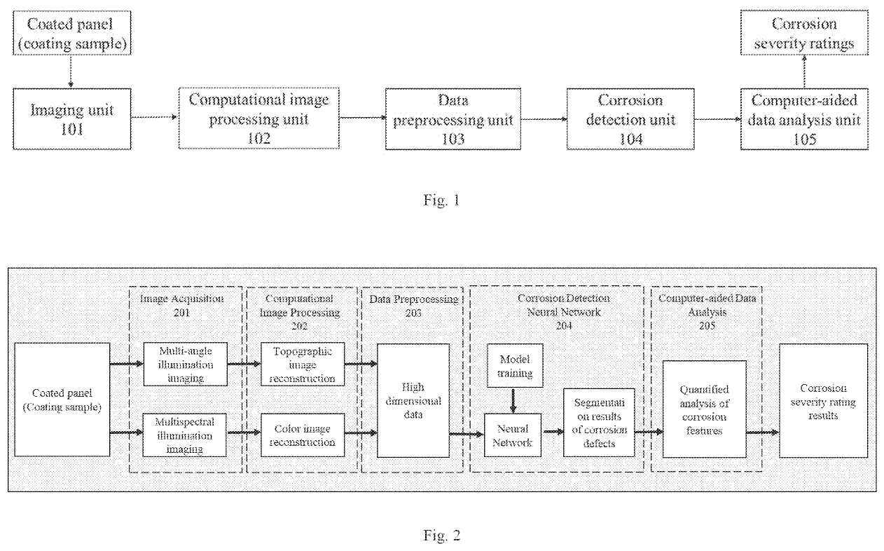

FIG. 1 illustrates a schematic diagram of a system for evaluation of anti-corrosion properties of a coating on a corrosion susceptible substrate (“coated panel” or “coating sample”) in accordance with one example of the present invention. The system comprises an imaging unit 101, a computational image processing unit 102, a data preprocessing unit 103, a corrosion detection unit 104, and a computer-aided data analysis unit 105. The imaging unit 101 acquires a plurality of grayscale images of the coating surface of a coated panel as the input and the computer-acid data analysis unit 105 outputs corrosion severity ratings.

FIG. 2 illustrates a flow chart of a method of evaluating anti-corrosion properties of a coating when applied on a corrosion susceptible substrate in accordance with one example of the present invention. The method includes image acquisition 201, computational image processing 202, data preprocessing 203, corrosion detection neural network 204, and computer-aided data analysis 205. The imaging acquisition 201 includes multi-angle illumination imaging and multispectral illumination imaging, the images obtained from which are processed through topographic image reconstruction and color image reconstruction, respectively, in the computational image processing 202. The images obtained after computational image process 202 are combined into images containing high-dimensional data through data preprocessing 203. The high-dimensional data is then input to corrosion detection neural network 204. The corrosion detection neural network 204 has been trained by model training to output segmentation results of corrosion defects, including locations, classifications, and regions of corrosion features. These corrosion features are analyzed quantitively in computer-aided data analysis 205 which then outputs predicted rating results of corrosion severity.

### Imaging Unit and Image Acquisition

The system of the present invention comprises an imaging unit that is useful for image acquisition. The imaging unit is configured to capture a plurality of images of a coating applied on a corrosion susceptible substrate (“coated metal panel” or “coated panel”). The imaging unit typically enables the use of computational imaging including, for example, multi-angle imaging such as multi-angle illumination imaging, multispectral imaging such as multispectral illumination imaging, or combinations thereof. The imaging unit comprises an imaging device. The imaging device typically comprises a programmed illumination device and a camera. For example, the imaging device can comprise a multi-angle illumination imaging device and a multispectral illumination imaging device. Alternatively, the imaging device can comprise a device having both functions of multi-angle illumination imaging and multispectral illumination imaging. The camera in the imaging device can be an) grayscale cameras such as grayscale industrial cameras with more than 10 million pixels (e.g., 500 million pixels or more), and a data transferring and computer-controlled interface. Desirably, the plurality of grayscale images of the coating comprise images acquired through both multi-angle imaging and multispectral imaging, and more desirably, through multispectral illumination imaging and images acquired through multi-angle illumination imaging.

### Multi-Angle Illumination Imaging

Multi-angle or multiple directions mean four or more directions, and can be 5 or more, 6 or more, or even 8 or more directions, and desirably, 4 to 6 directions. “Multi-angle illumination imaging” refers to imaging by means of a multi-angle illumination device. The multi-angle illumination device is a device that can illuminate a sample with light in multiple directions to cast a directional shadow around raised or sunken features on the sample.

An imaging device comprising the multi-angle illumination device can also be referred to as a multi-angle illumination imaging device. An exemplary multi-angle illumination imaging device usually comprises a single camera to capture multiple images of a sample, i.e., a coating surface, illuminated by multiple light sources. The illumination source can be a ring light with four 90-degree quadrants, an array of four bar lights, or any other arrangement that produces multiple directional lighting.

The multi-angle illumination imaging device can be used to capture a plurality of images by firing segmented light arrays from multiple angles. The plurality of images can then be used to produce a reconstructed topographic image in a computational image processing unit described later that is configured to obtain shadow images in a process called “shape from shading.” The multi-angle illumination imaging can accentuate the three-dimensional surface structure of a sample, which is particularly suitable for detection of minor corrosion defects, and three-dimensional (3D) surface reconstruction, of the surface of a coating sample. Suitable examples of multi-angle illumination imaging devices may include LSS-2404 available from CCS America Inc. and CV-X series available from Keyence Corporation.

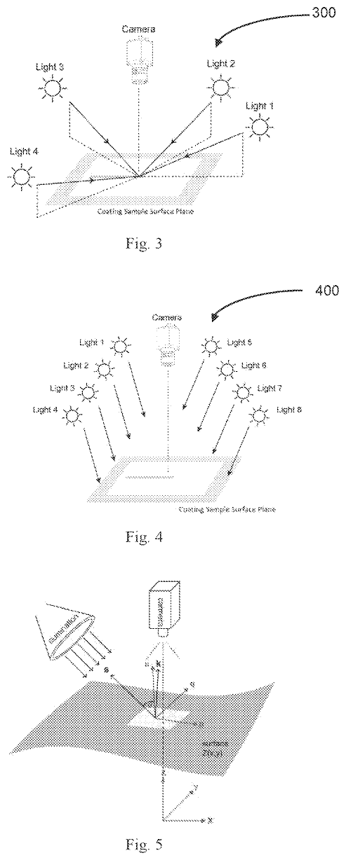

Using the multi-angle illumination imaging device in combination with a computational image processing unit described later can make visually noisy or highly reflective surfaces (such as glass) easy to inspect, which is particularly effective for coating surfaces that have 3D structure but little to no contrast. FIG. 3 illustrates a schematic example of a multi-angle illumination imaging device 300 in accordance with one example of the present invention. The multi-angle illumination imaging device 300 with different illumination angles includes a camera and one or more illumination devices emitting light in multiple different directions. e.g., Light 1, Light 2, Light 3 and Light 4. The surface plane of a coating sample is illuminated by the light in the different directions one by one so that multi-angle images of the coating sample with the same sequence are captured by the camera. Thus, a plurality of images of the surface of a coating sample (or a coated panel) are acquired by the multi-angle illumination imaging device, which can also be referred to as “multi-angle illumination images.”

### Multispectral Illumination Imaging

Multispectral” refers to four or more wavelengths, for example, 4 to 16 wavelengths or 4 to 8 wavelengths. “Multispectral illumination imaging” refers to imaging by means of a multispectral illumination device. The multispectral illumination device is an illumination device with multiple light sources with different specified wavelengths. “Desirably, a multispectral illumination device with light of eight or more spectral channels can be used to obtain more accurate color information and distinguish between different classifications of corrosion features on the coating surface based on such color information comparing with conventional digital color cameras. “Digital color camera” refers to a common color camera for industrial and domestic use with a Bayer filter. A Bayer filter is a color filter array (CFA) for arranging RGB color filters on a square grid of photosensors.

An imaging device comprising the multispectral illumination device is also referred to as multispectral illumination imaging device. Such device can provide a more simplified and practical solution for industrial imaging applications as compared to hyperspectral imaging devices. An assortment of light source (such as LED source) wavelengths can be chosen. For example, LED light sources with eight spectral channels and a monochrome grayscale camera can be used. Images captured by the multispectral illumination imaging device contain four or more spectral image planes, which represent four or more spectral channels such as ultraviolet (405 nanometers (nm)), Blue (457 nm), Green (527 nm), Orange (60 nm), Red (660 nm), Far red (730 nm). Infrared (860 nm), or White (600 nm), all wavelength values being approximate peak wavelength values. These images acquired by the multispectral illumination imaging device can be combined to produce a reconstructed color image in the computational image processing unit described later.

Under the illumination of the light source of each spectral channel, a corresponding signal intensity image of a coating sample in the spectral region can be obtained. For example, when the imaging is completed in sequence under the illumination of eight spectral channels, eight response intensity images of a coating sample under the eight spectral channels are captured. Then the intensity of the eight spectral positions into the corresponding RGB or Lab color values can be reconstructed into a color image according to the computational image processing unit described later. Thus, a plurality of the images captured by the multispectral illumination imaging device may comprise the response intensity images under the spectral channels. Alternatively, a grayscale camera can be used along with a light source that contains independently controlled multiple spectral lighting channels. As the light source cycles through each individual spectral channel, a subsequent image is captured. Each of these images corresponds to the coating's reflectance for individual spectral lighting. These images can be combined and reconstructed into one color image later.

Using the multispectral illumination imaging, a specified corrosion feature can also be distinguished from others on an image depending on how they respond to various spectral lighting. The image resolution of the multispectral illumination imaging matches the full pixel resolution of the grayscale camera in the multispectral illumination imaging device. In contrast, when using conventional digital color camera imaging, multiple neighboring pixels are combined to resolve color, thus giving an image with relatively lower resolution. Therefore, the multispectral illumination imaging affords higher resolution at lower cost and with less system complexity comparing with the digital color camera imaging. Suitable examples of multispectral illumination imaging devices may include HPR2 Series available from CCS America Inc. and CA-DRM10X available from Keyence Corporation.

FIG. 4 illustrates a schematic example of a multispectral illumination imaging device in accordance with one example of the present invention. The multispectral illumination imaging device 400 includes a camera and one or more illumination devices emitting light of multiple different wavelengths. e.g., Light 1, Light 2, Light 3, Light 4, Light 5, Light 6, Light 7 and Light 8. Thus, a plurality of images of a coating sample are acquired by the multispectral illumination imaging device, which can also be referred to as “multispectral illumination images.”

Desirably, the plurality of grayscale images of the coating for inputting to the computational image processing unit described later (that is used for computational imaging processing) comprise the multi-angle illumination images and the multispectral illumination images.

### Computational Image Processing Unit and Computational Image Processing

The system of the present invention also comprises a computational image processing unit that is useful for computational image processing. The computational image processing unit is configured to reconstruct the captured plurality of grayscale images of the surface of the coating sample and to output a reconstructed topographic image and a reconstructed color image. The computational image processing is capable of reconstructing images using computer vision technology.

### (A) Reconstruction of a Topographic Image

The plurality of the grayscale images of the coating sample (“original images”) may comprise the images captured from different illumination angles, e.g., the images that are acquired by the multi-angle illumination imaging device, which can be reconstructed into a topographic image using surface height map information by a shape-from-shading algorithm. The shape-from-shading algorithm may adopt a height driven process, where surface colors or features without height are removed, and a computed surface image is output based on the shading information. Reconstruction of the topographic image using the surface height map Z(x,y) may be performed by the shape-from-shading algorithm in two steps. In the first step, gradients in x- and y-directions denoted “p” and “q”, respectively, can be calculated from captured grayscale images. In the second step, a topographic image is derived by integration of the gradients.

FIG. 5 is a schematic illustration of the principle of “shape-from-shading” algorithm. The intensity recorded by a camera depends mainly on the angle between the direction vector (“s”) of the incident light and the normal vector (“n”) of the observed surface element.

In general, the z-axis of the real world coordinate system can be chosen to coincide with the optical axis of the camera. The image plane is therefore parallel to the xy-plane of the coordinate system. The intensity. I(x,y) registered by the camera depends only on the following parameters, the sensitivity (“c”) of the camera sensor, the direction vector (“s”) and the intensity (“Q”) of the incoming, telecentric light, and the fraction (“R(n,s)”) of the light reflected towards the camera:

I(x,y)=c·Q(x,y,z)·R(n,s)

The reflectance map of R(n,s) describes all details concerning the reflection of light. R depends on the material-dependent and position-dependent reflection coefficients (“r”) for diffuse and specular reflection, and on the angle (“θ”) between the direction-vector (“s”) of the incoming light and the unknown normal (“n”) of the considered surface element. Considering only diffuse reflections (Lambert's law) thus yields:

R(n,s)=r·cos θ with cos θ=n·s

This result does not depend on the viewing direction of the camera. For suppression of specular reflection, camera and lamps should be positioned in such a way that according to the rule “incident angle=reflection angle” the specular reflected light is deflected away from the camera lens as much as possible.

The intensity recorded in each pixel of the camera corresponding to a volume element of the surface is therefore described by:

I(x,y)=c·Q·r·n·s=ρ·n·s (with albedo ρ=c·Q·r)

Under these premises, the influences of c, Q and r cannot be separated. They are therefore combined in a single variable known as albedo.

The normal vectors “n” of the surface elements are defined by the gradients of the surface Z(x,y) in x- and y-direction, i.e. by the partial derivatives of Z(x,y) with respect to x and y:

$$n = \frac{1}{\sqrt{1 + {p}^{2} + {q}^{2}}} ( \begin{matrix}- p \\ - q \\ 1\end{matrix} ) \text{?} p = \frac{\partial Z}{dx} and q = \frac{\partial Z}{dy}$$

$$\text{?} \text{indicates text missing or illegible when filed}$$

At least three independent equations and therefore at least three pictures for different light directions are required to eliminate p and to calculate the gradients p and q. Improved results and an estimation of measuring errors can be achieved if more than three pictures are captured and hence leading to an over-determined system of linear equations. After solving the equation system using standard methods, a topographical image is calculated by integration over p and q (further details of shape-from-shading algorithm can be referenced to B. K. P. Horn and M. J. Brooks (eds.), Shape from Shading, MIT Press 1989).

In the anti-corrosion testing for coatings when applied on a corrosion susceptible substrate (e.g., a metal), corrosion often causes changes in the surface morphology of the coatings, for example, uneven defects forming on the originally flat surface of the coatings. The computational image processing using shape from shading can quickly characterize uneven corrosion defects of large-area samples and provide the resulting topographic image with a quality similar to a conventional three-dimensional surface scanning testing (e.g., 3D laser scanning measurement which can plot a 3D map of a sample surface step by step), while taking shorter time than the 3D surface scanning testing.

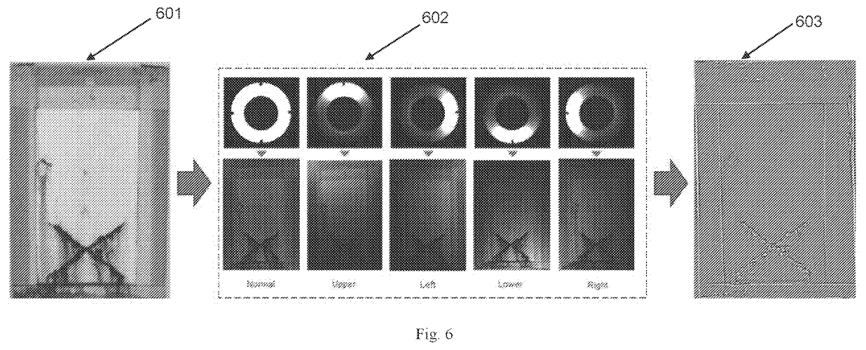

FIG. 6 illustrates a schematic flowchart for obtaining a topographic image from the multi-angle illumination images of a coated metal panel according to one example of the present invention. A coated steel panel 601 (i.e., a coating which is applied onto a steel panel) after exposure to the ASTM B117-11 salt spray test is provided. Multiple grayscale images 602 are taken using a multi-angle illumination imaging device with lighting from different angles, where “Normal” represents all lights are on, “Upper” represents upper position light is on, “Left” represents left position light is on. “Lower” represents lower position light is on, and “Right” represents right position light is on. The obtained multi-angle images are then processed by the shape-from-shading algorithm; thereby obtaining a reconstructed topographic image 603.

### (B) Reconstruction of a Color Image

The plurality of the grayscale images of the coating (“original images”) may comprise images at different wavelengths, e.g., images that are acquired by the multispectral illumination imaging device above. For example, eight images can be collected for eight different wavelengths. Reconstruction of a color image from multispectral illumination images can be conducted using a spectral reconstruction algorithm. The spectral reconstruction algorithm can be based on the following process: for each image at a specified wavelength, the grayscale level represents the intensity of light reflected; based on these data, a reflectance spectral curve can be generated for each pixel, and the color value of each pixel can be calculated from the reflectance spectral curve; and then a color image can be reconstructed from each pixel's color value.

The CIE 1931 color spaces created by the International Commission on Illumination (CIE) in 1931 can be used for image reconstruction. For each pixel, the XYZ tristimulus values can be calculated from spectral data. According to the definition of tristimulus values, assuming that the spectral distribution function of the reflected light of a certain object is φ(λ), and the spectral tristimulus function is to decompose φ(λ) according to the spectral tristimulus value, the tristimulus value corresponding to each wavelength can be obtained, and then integrate it from the whole visible light band to obtain the color tristimulus value as shown in the below formula:

$$\{ \begin{matrix}X = {\int }_{λ} k φ ( λ ) \overline{x} ( λ ) d λ \\ Y = {\int }_{λ} k φ ( λ ) \overline{y} ( λ ) d λ \\ Z = {\int }_{λ} k φ ( λ ) \overline{z} ( λ ) d λ\end{matrix}$$

where k is the adjustment factor, and x̅, y̅, z̅ are the CIE standard observer functions (10 degree). Typically, the value of k is 100. The tristimulus values can also change by adjusting the value of k.

Then, the resulting X, Y, and Z values are substituted into the below formula to obtain the R, G, and B stimulus values of the target reflection spectrum entering the human eye:

$$[ \begin{matrix}R \\ G \\ B\end{matrix} ] = [ \begin{matrix}3.240479 , & - 1.53715 , & - 0.498535 \\ - 0.969256 , & 1.875992 , & 0.041556 \\ 0.055648 , & - 0.204043 , & 1.057311\end{matrix} ] [ \begin{matrix}X \\ Y \\ Z\end{matrix} ]$$

By calculating the chromaticity coordinates, the position of the color light in the CIE color space can be obtained (Further details can be referenced to: http://www.brucelindbloom.com/index.html?Eqn_Spect_to_XYZ.html).

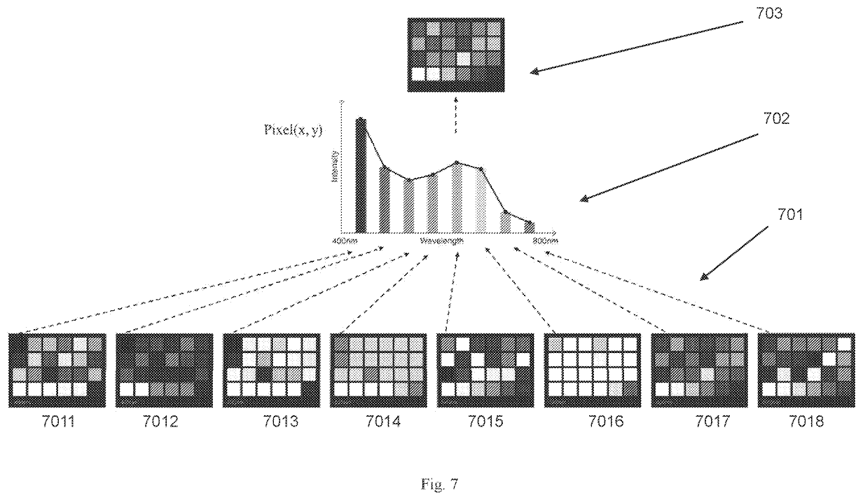

FIG. 7 illustrates a schematic diagram of color image reconstruction from multiple single-wavelength-illumination images. Eight grayscale images are generated from a multispectral illumination imaging device 702 with eight spectral channels 7011 through 7018 with wavelengths of 450 nm, 475 nm, 495 nm, 525 nm, 545 nm, 580 nm, 620 nm, and 670 nm, respectively. For each pixel (x, y) (x and y mean the position of pixel on the image), such as pixel (0, 0), a reflectance spectral curve 702 with eight data points can be generated. Then the color value for such pixel can be calculated from its reflectance spectral curve. After the color values of every pixel are generated, together with the position for each pixel, a color image 703 with 24 colors, where each of 24 grids represents a different color, is reconstructed.

FIG. 8 illustrates a computational color image reconstructed from images of a coated panel captured by a multispectral illumination imaging device in accordance with one example of the present invention. Eight grayscale images 801 from eight spectrum lighting are processed in the computational image processing unit using the spectral reconstruction algorithm to obtain one reconstructed color image 802.

The reconstructed color image enables smaller color differences existed on the surface of a coated panel to be differentiated comparing with images captured by conventional digital color cameras.

Desirably, the multi-angle illumination imaging device and the shape-from-shading algorithm are used to obtain the surface height map of a coated panel, thereby giving the reconstructed topographic image; and then the multispectral illumination imaging device and the spectral reconstruction algorithm are used to obtain the color information on the sample surface; thereby giving the reconstructed color image.

### Data Preprocessing Unit and Data Preprocessing

The system of the present invention also comprises a data preprocessing unit that is useful for preprocessing data output from the computational image processing unit. The data preprocessing unit is configured to combine the reconstructed topographic image and the reconstructed color image into images containing high-dimensional data. That is, the high-dimensional data is generated from the outputs of the computational image processing unit described above. Then the high-dimensional data is used as the input to the corrosion detection unit described later.

“High-dimensional data” herein means data with at least four dimensions. The high-dimensional data in the present invention comprises one-dimensional surface height data and at least three-dimensional color data (e.g., three or more color dimensions for each pixel on a sample image), and can have 4 or more, 5 or more, 9 or more, or even 10 or more color dimensions. The high-dimensional data, i.e., combined image data, will be used as a combined input for a corrosion detection unit described later. For each pixel on a sample image, a deep learning neural network in the corrosion detection unit described later will use the color data and the surface height data together.

The reconstructed topographic image obtained from the computational processing unit above is processed by grayscale values which represent surface height values and converted to one-dimensional data for surface height. The reconstructed color image obtained from the computational processing unit above can be processed by the reflectance intensity of a sample when illuminated by different spectral wavelengths and converted to at least three-dimensional data for color. The at least three-dimensional color data and the one-dimensional surface height data are then combined by matrices addition operation into the high-dimensional data.

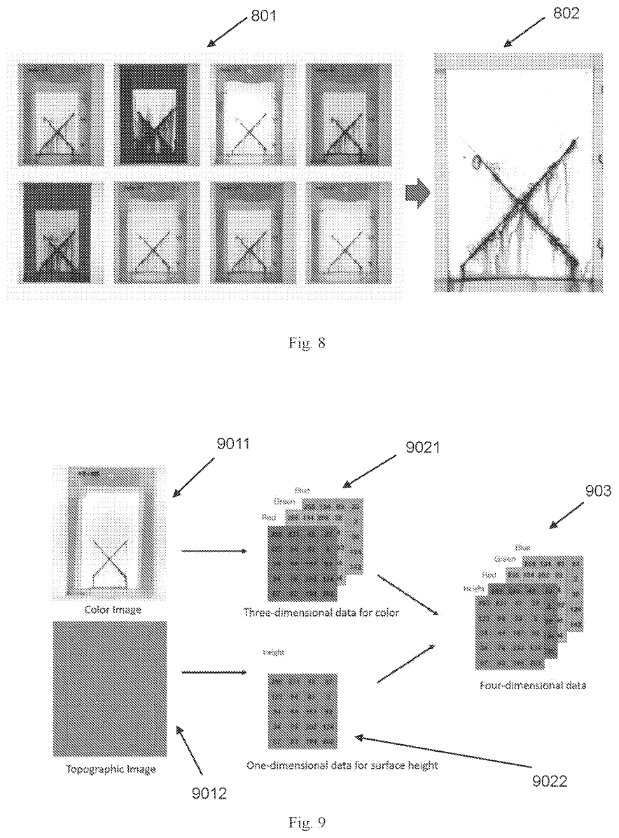

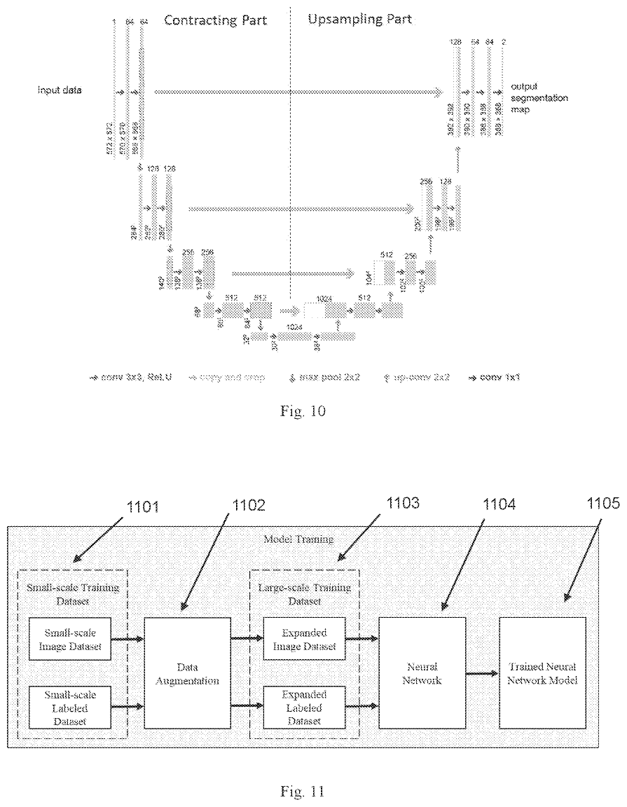

FIG. 9 is a schematic illustration of high-dimensional data combined from the outputs of the computational image processing unit in accordance with one example of the present invention. The reconstructed color image 9011 is processed by the reflectance intensity of Red, Green and Blue (RGB) spectral channels and converted to three-dimensional data for color 9021 (numbers representing reflectance intensity). The reconstructed topographic image 9012 is processed and converted to one-dimensional data for surface height 9022 (numbers representing reflectance intensity). The three-dimensional color data and the one-dimensional surface height data are combined into a four-dimensional data 903 (numbers representing reflectance intensity) by matrices addition operation.

The combination of data in the reconstructed topographic image and in the reconstructed color images, thereby forming the high-dimensional data, enables the present invention to distinguish actual rusting from rust bleed on a coating surface. “Rust bleed” refers to color contaminations on the coating surface, for example, caused by the flow of a salt solution in the ASTM B117-11 salt spray test.

### Corrosion Detection Unit and Corrosion Detection and Recognition

The system of the present invention also comprises a corrosion detection unit that is useful for detection of corrosion features. The corrosion detection unit is configured to receive the high-dimensional data and recognize corrosion features and to output at least locations, classifications, and regions of corrosion features. The corrosion detection unit can be a one-step deep learning unit comprising a corrosion detection neural network. “Corrosion detection neural network” herein refers to a neural network for recognition of corrosion defects. The corrosion detection neural network has an input layer and an output layer. An input data to the input layer contains the high-dimensional data obtained above. An output data from the output layer contains data for at least locations, classifications, and regions of corrosion features.

The corrosion detection neural network is to realize image segmentation, particularly, semantic segmentation, for different corrosion defects on the images containing the high-dimensional data. Image segmentation is an image processing method on partitioning an image into different parts according to their features and properties. Semantic segmentation, a type of image segmentation, assigns a class to every pixel in a given image. Comparing with other types of image segmentation that aim at grouping similar regions of an image, semantic segmentation is particularly useful for quantification of corrosion features such as locations, classifications, or sizes using deep learning.

U-Net neural network can be used to realize the semantic segmentation functionality for a defined corrosion feature in the corrosion detection neural network (further details of U-Net neural network can be found in Ronneberger, Olaf. Philipp Fischer, and Thomas Brox. “U-net: Convolutional networks for biomedical image segmentation.” International Conference on Medical image computing and computer-assisted intervention. Springer, Cham, 2015). The U-Net neural network is to supplement a usual contracting network by successive layers, where pooling operations are replaced by upsampling operators. Hence these layers increase the resolution of the output. A successive convolutional layer can then learn to assemble a precise output based on the upsampling operating results. Comparing with fully convolutional network, one modification in the U-Net neural network is that there are a large number of feature channels in the upsampling part, which allow the network to propagate context information to higher resolution layers. As a consequence, the expansive path is symmetric to the contracting part and yields a U-shaped architecture. The U-Net neural network only uses the valid part of each convolution without any fully connected layers. FIG. 10 illustrates a schematic diagram of a typical U-Net neural network used in corrosion detection neural network.

To further improve the prediction accuracy of the present invention, the corrosion detection unit may also comprise a region of interest (ROI) neural network prior to the corrosion detection neural network. “ROI neural network” refers to a neutral network for recognition of regions of interest. The ROI neural network is configured to receive the high-dimensional data as the input data and output ROI recognition results. Based on the ROI recognition results, boundaries of the regions of interest can be extracted from the high-dimensional input data, thereby obtaining ROI extracted data (i.e., high-dimensional data after ROI extraction). The ROI extracted data is then input into the corrosion detection neural network which can predict at least the locations, classifications, and regions of the corrosion defects as outputs.

### Model Training Process

The corrosion detection neural network may comprise a model training unit useful for a model training process. The model training process useful in the present invention is used to train deep learning neural networks using training datasets using training coated panels (also as“training coatings”).

A corrosion detection training dataset is used to train a corrosion detection model deployed on the corrosion detection neural network, thereby forming a trained corrosion detection model deployed on the trained corrosion detection neural network that can predict at least locations, classifications, and regions of the corrosion defects. The corrosion detection training dataset comprises a set of high-dimensional data for training coated panels and a set of data containing the corresponding actual corrosion features. The high-dimensional data for the training coated panels are obtained by: (i) collecting a plurality of grayscale images of each training coated panel, (ii) reconstructing the captured grayscale images for each training coated panel and outputting a reconstructed topographic image and a reconstructed color image by computational imaging processing for each training coated panel; (iii) combining the reconstructed topographic image and the reconstructed color image for each training coated panel; thereby forming images comprising the high-dimensional data for each training coated panel, comprising one-dimensional height data and at least three-dimensional color data. Steps (i), (ii), and (iii) can be conducted according to the description in the imaging unit, the computational imaging processing unit, and the data preprocessing unit section above. The actual corrosion features, including actual locations, classifications, and regions, of such training coated panels can be identified according to a quantified degree of rusting, degree of blistering, and maximum creepage, or according to ASTM D610-08. ASTM D714-02, and ASTM D1654-08. For example, these corrosion features can be labelled by human through visual inspection of the training coated panels. Experienced laboratory operators can use the LabelMe tool to manually label regions of corrosion features by visual inspection of the training coated panels, for example, using different label classes for different classifications of corrosion defects such as rusting, blistering, and creepage according to ASTM D610-48. ASTM D714-02, and ASTM D1654-08, respectively. LabelMe is a graphical image annotation tool developed by Computer Science and Artificial Intelligence Laboratory. Massachusetts Institute of Technology (MIT), U.S.A, on http://labelme.csail.mit.edu. In one embodiment, creepage is labelled as one class, and blistering and rusting are labelled as another class for training coating panels.

A ROI training dataset is used to train a ROI model deployed on the ROI neural network, thereby forming a trained ROI model deployed on the trained ROI neural network that can predict regions of interest (ROIs). The ROI training dataset comprises a set of the high-dimensional data for the training coated panels and a set of data containing corresponding ROIs (“actual ROIs”) of such training coated panels labelled by human. The high-dimensional data for the training coated panels is obtained as described above. The regions of interest of the training coated panels are labelled by human through visual inspection of the training coated panels, for example, using the LabelMe tool.

The size of the training dataset is important to prediction accuracy of the neural network models. Generally, a large-scale training dataset (more than 10.000 samples) can greatly improve the accuracy of model prediction. FIG. 11 illustrates a model training process for a deep learning neural network in accordance with one example of the present invention. A training process uses a training dataset using a plurality of training samples (e.g., 20 samples), referred to as “original training dataset”, that is small-scale training dataset 1101. The small-scale training dataset 1101 comprises a small-scale image dataset (i.e., high-dimensional data) and a small-scale labeled dataset (i.e., human-labelled corrosion features or human-labelled ROI). The small-scale training dataset 1101 can be further expanded using data augmentation algorithm 1102 to 1000-2000 times of the number of the dataset, and then a training dataset of tens of thousands of pictures can be obtained, forming an expanded training dataset 1103 comprising a corresponding expanded image dataset and an expanded labeled dataset. The expanded training dataset 1103 is used for training neural network 1104 to obtain trained neural network model 1105. Data augmentation in data analysis is a technique used to increase the amount of data by adding slightly modified copies of already existing data or newly created synthetic data from existing data. Data augmentation can act as a regularizer and help reduce overfitting when training a deep learning model. Data augmentation can increase the diversity of data available for training models without actually collecting new data. The training dataset used in the present invention can be first expanded using data augmentation algorithm before training the neural network to further improve the accuracy of the models. Commonly used data augmentation techniques such as de-texturizing, de-colorizing, cropping, padding, and horizontal flipping can be used in training neural networks.

In the model training process, among an original training dataset, 10%-30% of the original training dataset can be randomly selected as a cross-validation dataset, and the rest is used as a new training dataset. Such new training dataset is used to train a U-Net neural network. At the end of each iteration, the cross-validation data set will be used to validate the model. If the accuracy is not high enough (e.g., greater than 95%), the model training unit will continue to optimize next iteration. After a certain number of iterations (e.g., 300-500 iterations), if the model's prediction accuracy on the cross-validation dataset reaches a relatively high accuracy, e.g., greater than 95%, the training iteration can be stopped and the trained model is produced.

### Prediction Process

The corrosion detection unit of the present invention may also comprise a prediction unit comprising comprises one or more neural networks deployed with the trained models and has the capability of predicting or outputting the at least locations, classifications, and sizes of the corrosion defects, and/or regions of interest, when receiving the input high-dimensional data.

The trained corrosion detection model and the trained ROT model obtained from the training process can be deployed in a corrosion detection neural network and a trained ROI neural network, respectively. A neural network deployed with the trained corrosion detection model is also referred to a “trained corrosion detection neural network.” A neural network deployed with the trained ROI model is also referred to as a trained ROT neural network.” When receiving the high-dimensional data of a coated panel, the trained corrosion detection neural network can recognize corrosion defects and output segmentation results of corrosion defects (also as recognition results of corrosion defects) including data containing at least locations, classifications, and regions of corrosion defects for such coated panel. When receiving the high-dimensional data of a coated panel, the trained ROI neural network can recognize the regions of interest and output segmentation results of ROI. The corrosion detection neural network and the region of interest neural network each independently can use a U-Net neural network.

When the system acquires new grayscale images. e.g., images of a test coating, these new images are processed into the high-dimensional data (as the input data) comprising surface height map data and color data relating to these new images, and the high-dimensional data is input into the neutral network that has been trained and such neutral network can then generate predicted results within a few seconds and mark the predicted results on the images. The prediction process can be performed by a deep learning neural network, e.g., U-Net neural network.

FIG. 12 shows a schematic flowchart of a one-step deep learning neural network for corrosion recognition and classification in accordance with one example of the present invention. One-step deep learning neural network herein means only one trained corrosion detection neural network is used. The high-dimensional data 1202 for the new grayscale images is input into the trained corrosion detection neural network 1204 directly (i.e., neural network deployed with trained corrosion detection model), which then outputs corrosion defects recognition results 1206, which contain location and region data for creepage 1206A, and location and region data for rusting and blistering 1206B (output data). Therefore, locations, classifications, and regions of corrosion defects can be predicted by the trained corrosion detection neural network.

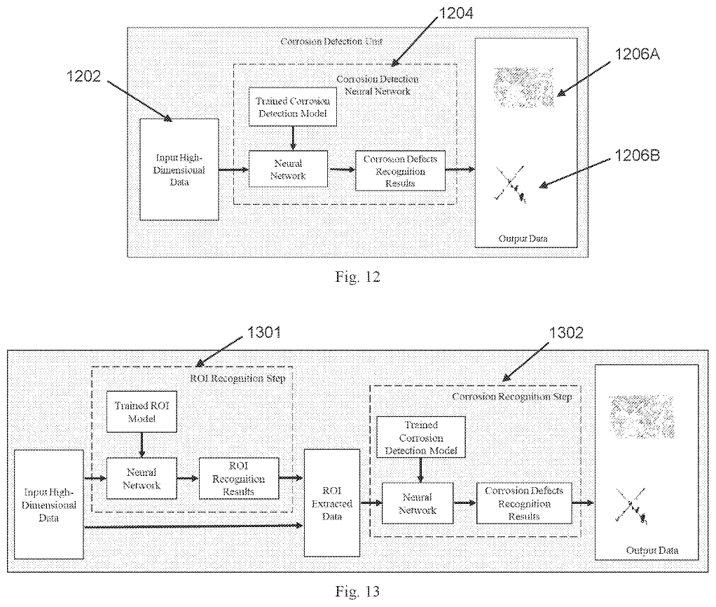

The corrosion detection unit may further comprise or be free of the trained ROT neural network. If there is clear background around a coated panel when grayscale images are taken, the system can use the one-step deep learning neural network without requiring a ROT neural network for recognition of regions of interest. FIG. 13 illustrates a schematic flowchart of a two-step deep learning neural network for corrosion recognition and classification in accordance with one example of the present invention. For example, the corrosion detection unit 1300 comprises the trained ROT neural network in a ROT recognition step 1301, followed by the trained corrosion detection neural network in a corrosion recognition step 1302. The trained ROT neural network receives the input data and outputs ROI recognition results. Based on the ROI recognition results, boundaries of regions of interest can be extracted from the high-dimensional input data, thereby obtaining ROI extracted data. e.g., high-dimensional data after ROI extraction. The ROI extracted data is then input into the trained corrosion detection neural network as the second step following the same procedure as the one-step deep learning neural network described above. The trained corrosion detection neural network is then output recognition results of corrosion defects, which include data containing at least locations, classifications, and regions of corrosion defects (the output data). That is, the output data from the output layer of the trained corrosion detection neural network contains at least predicted locations, classifications, and regions of corrosion features.

### Computer-Aided Data Analysis Unit

The system of the present invention further comprises a computer-aided data analysis unit that is useful for receiving and analyzing the output data from the corrosion detection unit. The computer-aided data analysis unit can also have the functionality to distinguish between the blistering defects and the rusting defects in the output data. The computer-aided data analysis unit is configured to provide predicted ratings of corrosion seventy by analyzing the corrosion feature data that is output from the corrosion detection neural network. The computer-aided data analysis may include image analysis and data statistics methods that are known in the art. The computer-aided data analysis can be conducted using an automated measurement algorithm.

After the corrosion detection neural network that has been trained recognize corrosion features, and, if present, the ROI neural network that has been trained recognizes the boundary of regions of interest, these output results relating to corrosion features are further evaluated by the computer-aided data analysis unit to predict ratings for corrosion severity. The output data for corrosion severity ratings may include locations of defects, classifications in different colors, one-side creepage width, two-side creepage width, rusting degree and blistering degree, or combinations thereof. “Creepage” means the width of corrosion at scribe line on a coated panel. There are two major types of scribe marks in the industry for creepage evaluation: single straight line and cross line. The creepage grows from the scribe, so “one-side creepage” means the width of corrosion region on one single side of the scribe and “two-side creepage” means the width of corrosion region on both sides of the scribe is calculated as the whole creepage width.

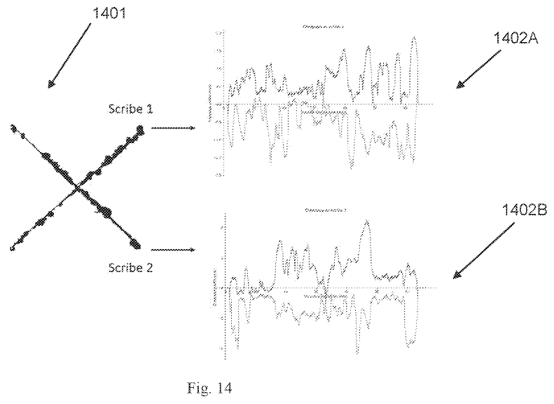

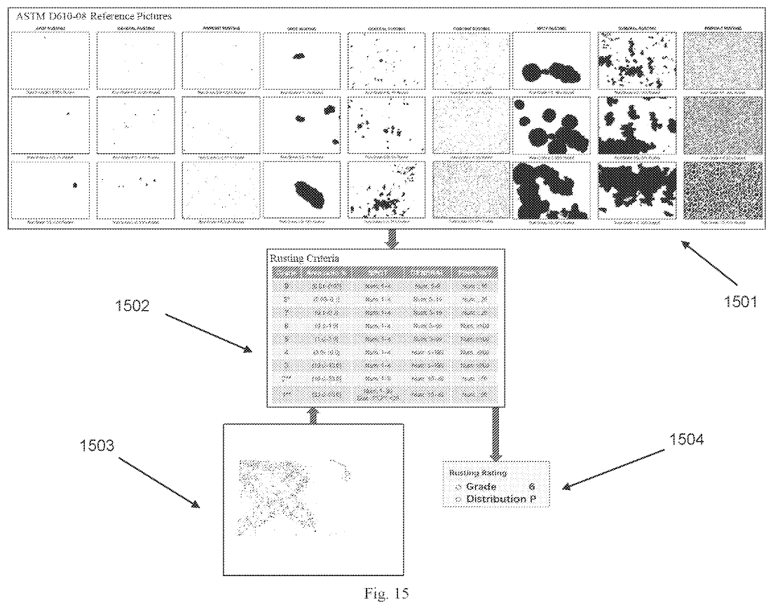

FIG. 14 illustrates an example of creepage calculation in accordance with one example of the present invention. A scribe mark “X” 1401 including Scribe 1 and Scribe 2 for a coated panel is output from the corrosion detection neural network. The outlines of corrosion regions at each scribe are extracted and given in FIGS. 1402A and 1402B, respectively, where x-direction is the direction of each scribe line and y-direction is the direction of corrosion growth. And the maximum distance in y-axis between the two outlines for each scribe line is calculated.

In manual visual inspection, rusting defects and blistering defects are difficult to differentiate from each other. Differences between rusting defects and blistering defects are that rusting defects cause color changes on the coating surface of a coated panel while blistering defects do not. Thus, the reconstructed color image obtained above can be used to help distinguish rusting defects from blistering defects based on average color values for the defects. For each corrosion defect output from the corrosion detection neural network, the average color values inside each corrosion defect are checked to determine whether it is a rust. As there is a superposition effect between the color of a coating and the color of rust on such coating surface, the criteria of average color values for determination of rusting on coatings with different colors may be different. For a corrosion defect on gray and black coatings, the average RGB (red, green and blue) color indices used to determine if it is rust are as follows:

If a corrosion defect on gray coatings has R<82 and G<51 and B<51, it is classified as rust; and

If a corrosion defect on black coatings has R>7 and G>7 and B>7, it is classified as rust.

For white coatings, the reconstructed color image is first converted to its gray version with [0,1] as the gray value range. If the average gray value of a corrosion defect on white coatings <0.5, then it is classified as rust.

To automatically determine the color of coatings, the average RGB color indices of all background regions inside the regions of interest are used. Background regions mean the regions that are free of creepage, rusting, or blistering. The following color index ranges are used in determination of colored coatings:
Black coating: R<20 and G<13 and B<10;
Gray coating: 62<R<133 and 59<G<122 and 48<B<112; and
White coating: R>195 and G>174 and B>126.

Degree of blistering and degree of rusting can be rated based on analyzing the evaluation criteria in accordance with ASTM D714-02 and ASTM D610-08, respectively. For characteristics of blistering, the severity grade is first evaluated based on the size of the largest bubble (e.g., top ten largest blisters in area) and then distribution of blistering is evaluated based on the density of blisters (i.e., the number of blisters in a certain area). Blistering evaluation can be conducted according to ASTM D714-02 standard. For characteristics of rusting, the severity level is firstly calculated mainly based on the area ratio of the rusted area (i.e., percentage of surface area rusted relative to total area), and then distribution of rust is calculated mainly by locations of different rust in combination with various rust sizes. Rusting evaluation can be conducted according to ASTM D610M8. The rating criteria for blistering evaluation and rusting evaluation can be quantified based on analysis of pictures and statistics in the reference standards given in ASTM D714-02 and ASTM D610-08, respectively.

FIG. 15 illustrates an exemplary process for rating rusting on a coated panel in accordance with one example of the present invention. Firstly, the rusting defects 1503 are extracted from the output data from the corrosion detection neural network where the rust defects are determined and identified based on the average color value criteria described above. Then the amount and size distribution of the rusting defects are calculated and comparing with rusting criteria 1502. The final rusting rating results 1504 are generated from the calculation automatically. Rusting criteria 1502 is obtained as follows: Reference standards 1501 for visual examples given in FIGS. 1-3 of ASTM D610-08 are analyzed and the rust distribution type (i.e., Spots. General, and Pinpoint) is quantified by the number of rusted regions corresponding to each rust grade. “Area ratio %” is the percent of surface area rusted relative to total area as given in Table 1 in ASTM D610-08.

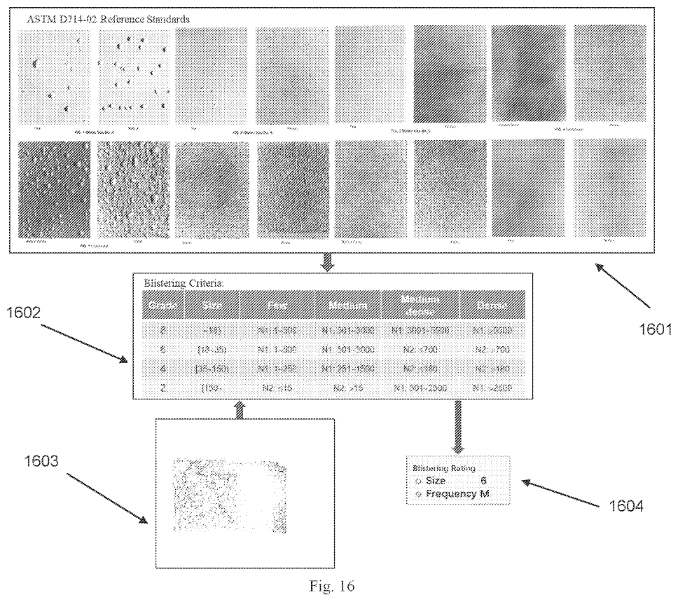

FIG. 16 illustrates a process for rating blistering on a coated panel in accordance with one example of the present invention. Firstly, the blistering defects 1603 are extracted from the output data from the corrosion detection neural network after the rusting defects are excluded. Then the amount and size distribution of blistering defects are calculated and comparing with the blistering criteria 1602. The final blistering ratings results 1604 are generated from the calculation automatically. Blistering criteria 1602 is obtained as follows: The photographic reference standards 1601 for blistering given in FIGS. 1-4 in ASTM D714-02 are analyzed and quantified by the number of blistering regions in corresponding to the size and density (Few. Medium, Medium dense, and Dense). “Size” of blister is counted in pixel (I pixel=0.035 mm²) and included into the blistering criteria 1602.

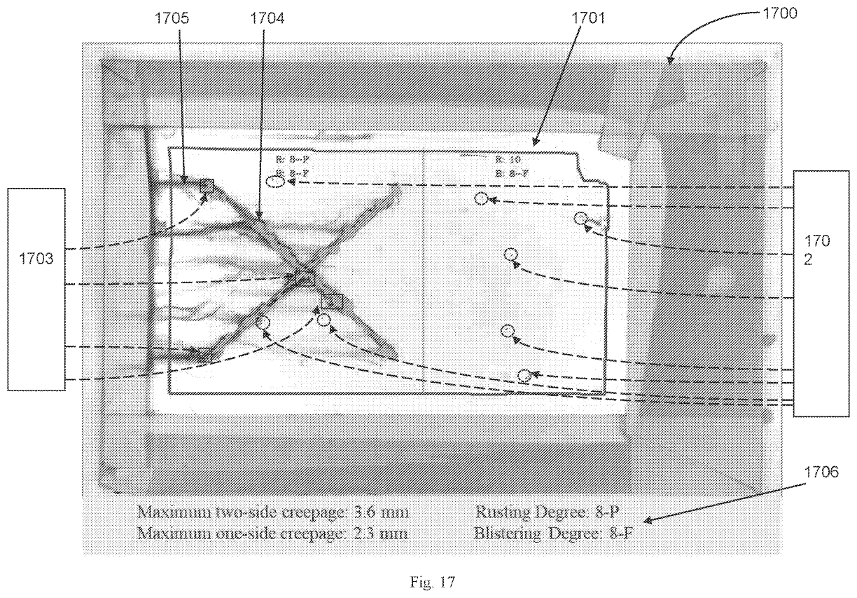

FIG. 17 gives one type of final output image from the inventive system in accordance with one example of the present invention. The final output image is obtained by overlaying the output data from the corrosion detection neural network and the computer-aided data analysis results on the reconstructed color image obtained in the computational processing unit. The image 1700 comprises boundaries of regions of interest 1701, within the boundary frame 1701 are regions of interest and outside the boundary frame are regions of uninterest, blisters 1702 (shown in Red), rust 1703 (shown in Blue), creepage regions in the “X” scribe 1704, rust bleed 1705, and predicted rating results of corrosion severity 1706. To highlight the blisters and rust on the image, some of the rust is marked within solid squares, and some blisters are marked within dash circles. The predicted ratings of corrosion severity include maximum one-side creepage and maximum two-side creepage in millimeter (mm), degree of rusting, and degree of blistering.

The present invention also relates to a computer-implemented method of evaluation of anti-corrosion properties of a coating when applied on a corrosion susceptible substrate, i.e., the coated panel descried above. The method may comprise receiving a plurality of grayscale images of the coating; reconstructing the plurality of grayscale images by computational image processing and outputting a reconstructed topographic image and a reconstructed color image; combining the reconstructed topographic image and the reconstructed color image into images containing high-dimensional data comprising one-dimensional height data and at least three-dimensional color data; inputting the high-dimensional data to a corrosion detection unit configured to recognize corrosion features and to output at least locations, classifications, and regions of corrosion features, wherein the corrosion detection unit comprises a corrosion detection neural network having an input layer receiving an input data and an output layer outputting an output data, wherein the input data contains the high-dimensional data and the output data contains at least locations, classifications, and regions of corrosion features; and analyzing the at least locations, classifications and regions of corrosion defects obtained from the corrosion detection unit and outputting predicted ratings of corrosion severity by computer-aided data analysis. The resulting predicted ratings of corrosion severity can be used to validate a coating composition (which can be labelled as “pass” or “fail” for the anti-corrosion properties), modify a coating composition, or adjust the time interval for coating maintenance when using a coating composition on a corrosion susceptible substrate a sue previous version of the draft). Each step in the method is as described in the corresponding unit of the system of the present invention above. Desirably, the plurality of grayscale images comprise images acquired from both multi-angle imaging and multispectral imaging, and more desirably, acquired through both multispectral illumination imaging and multi-angle illumination imaging. The present invention can give a high prediction accuracy of ratings of corrosion severity for a defined corrosion feature, as indicated by a regression coefficient >80% comparing with human evaluation results. The regression coefficient, R², normally ranges from 0 to 1 and can be calculated according to equation (I) below:

$${R}^{2} = 1 - \frac{{\sum }_{i} {( {y}_{i} - )}^{2}}{{\sum }_{i} {( {y}_{i} - \overline{{y}_{i}} )}^{2}} \qquad ( I )$$

where yᵢ is the actual value of a corrosion feature rated by human panelists through visual inspection, i is the sample data point, and ŷᵢ is the model predicted value of such corrosion feature, and y̅ᵢ̅ is the mean value for the actual value of a corrosion feature rated by human panelists through visual inspection. The higher the R², the better the model fits a dataset.

The present invention also relates to a process for training a neural network for detection corrosion on a coating when applied on a corrosion susceptible substrate. The process comprises collecting a plurality of grayscale images of a set of coatings applied on a corrosion susceptible substrate (that is, the training coated panels or the training coating described above); reconstructing the captured grayscale images for each coating by computational processing and outputting a reconstructed topographic image and a reconstructed color image for each coating; combining the reconstructed topographic image and the reconstructed color image for each coating and outputting images containing high-dimensional data, comprising one-dimensional height data and at least three-dimensional color data, for each coating; obtaining at least actual locations, classifications, and regions of corrosion features for each coating which can be identified according to a quantified degree of rusting, degree of blistering, and maximum creepage; creating a training dataset comprising a set of the high-dimensional data and a set of data containing the at least actual locations, classifications, and regions of corrosion features for the set of coatings; and training the neural network using the training dataset; thereby obtaining the trained neural network, that is, the corrosion detection neural network described above. Alternatively, the actual locations, classifications, and regions of corrosion features for each coating can be identified according to ASTM D610-08, ASTM D714-02, and ASTM D1654-08. For example, these corrosion features can be labelled by human through visual inspection.

The present invention also relates to a computing device. The computing device useful in the present invention may comprise a processor and data storage, where the data storage has stored thereon computer-executable instructions that, when executed by the processor, cause the computing device to carry out functions of the computer-implemented method of evaluation of anti-corrosion properties of the coating on coated panels.

The present invention also relates to a computing device with the computational image processing unit, the data preprocessing unit, the corrosion detection unit, and the computer-aided data analysis unit, deployed thereon. The computing device can be a client device (e.g., a device actively operated by a user), a server device (e.g., a device that provides computational services to client devices), or some other type of computational platform. Some server devices can operate as client devices from time to time in order to perform particular operations, and some client devices can incorporate server features.

The processor useful in the present invention can be one or more of any type of computer processing element, such as a central processing unit (CPU), a co-processor (e.g., a mathematics, graphics, neural network, or encryption co-processor), a digital signal processor (DSP), an application specific integrated circuit (ASIC), a network processor, and/or a form of integrated circuit or controller that performs processor operations.

The data storage can include one or more data storage arrays that include one or more drive array controllers configured to manage read and write access to groups of hard disk drives and/or solid-state drives.

In some embodiments, the computing device can be deployed to support a clustered architecture. The exact physical location, connectivity, and configuration of these computing devices can be unknown and/or unimportant to client devices. Accordingly, the computing devices can be referred to as “cloud-based” devices that can be housed at various remote data center locations, such as a cloud-based server cluster. Desirably, the computing device is a cloud-based server cluster and inputting the concentration data to the decision tree ensemble is conducted via a web-based user interface where users can get access.

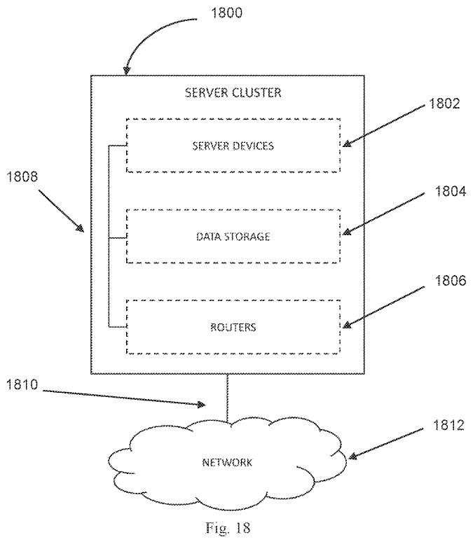

FIG. 18 depicts a schematic drawing of a cloud-based server cluster 1800 in accordance with one example of the present invention. Desirably, operations of a computing device can be distributed between server devices 1802, data storage 1804, and routers 1806, all of which can be connected by local cluster network 308.

The amount of server devices 1802, data storage 1804, and routers 1806 in the server cluster 1800 can depend on the computing task(s) and/or applications assigned to the server cluster 1800. For example, the server devices 1802 can be configured to perform various computing tasks of the computing device. Thus, computing tasks can be distributed among one or more of the server devices 1802. As an example, the data storage 1804 can store any form of database, such as a structured query language (SQL) database or trained model checkpoints. Furthermore, any databases in the data storage 304 can be monolithic or distributed across multiple physical devices. The routers 1806 can include networking equipment configured to provide internal and external communications for the server cluster 300. For example, the routers 1806 can include one or more packet-switching and/or routing devices (including switches and/or gateways) configured to provide (i) network communications between the server devices 1802 and the data storage 1804 via the cluster network 1808, and/or (ii) network communications between the server cluster 1800 and other devices via the communication link 1810 to the network 1812. The server devices 1802 can be configured to transmit data to and receive data from cluster data storage 1804. Furthermore, server devices 1802 can organize the received data into web page representations. Such a representation can take the form of a markup language, such as the hypertext markup language (HTML), the extensible markup language (XML), or some other standardized or proprietary format. Moreover, the server devices 1802 can have the capability of executing various types of computerized scripting languages, such as Perl, Python. PHP Hypertext Preprocessor (PHP), Active Server Pages (ASP), or JavaScript. Computer program code written in these languages can facilitate the providing of web pages to client devices, as well as client device interaction with the web pages.

### EXAMPLES

Some embodiments of the invention will now be described in the following Examples. All parts and percentages are weight percentages unless otherwise specified. The following standard analytical equipment and methods are used in the Examples and in determining the properties and characteristics stated herein below. OROTAN, KUAI YI, and ACRYSOL are trademarks of The Dow Chemical Company.

| Material | Description | Commercial Source | Function |
|---|---|---|---|
| SURFYNOL ™ TG | Non-ionic surfactant | Available from Evonik | Dispersant |
| Aqueous ammonia | | Available from Guoyao | Neutralizer |
| | | (China) | |
| TEGO ™ Airex 902W | Polyether siloxane copolymer | Available from Evonik | Defoamer |
| Ti-Pure ™ R-706 | TiO₂ | Available from Chemours | Pigment |
| PRINTEX ™ POWDER-4 | Carbon black | Available from The Cary | Pigment |
| | | company | |
| OROTAN ™ KUAI YI ™ | Hydrophobic copolymer dispersant | Available from The Dow | Dispersant |
| 731A dispersant | supplied in the sodium form | Chemical Company | |
| TEGO ™ Airex 901W | Polyether siloxane copolymer, | Available from Evonik | Defoamer |
| | containing fumed silica | | |
| BENTONE ™ LT | Organically modified special | Available from Elementis | Rheology |
| | smectite clay | | modifier |
| Nubirox 106 | Organophilized zinc phosphate | Available from Nubiola | Anticorrosive |
| | and zine molybdate | | pigment |
| BaSO₄ | 1500 mesh barium sulfate | Available from Guangfu | Filler |
| | | Jiancai (China) | |
| Sodium nitrite (15%) | | Available from Sinopharm | Anti-flash rust |
| | | Chemical Reagent Co., Ltd. | additive |
| Texanol | 2,2,4-Trimethyl-1,3-pentanediol | Available from Eastman | Coalescent |
| | monoisobutyrate | | |
| ACRYSOL ™ RM-8W | Hydrophobically modified ethylene | Available from The Dow | Rheology |
| thickener | oxide urethane | Chemical Company | modifier |
| Binders 1 to 22 used in | Styrene acrylic latex | Available from The Dow | Binder |
| the Examples section | | Chemical Company | |

### Salt Spray Test

Preparation of Coated Panel: A paint formulation was applied onto Q panels (cold rolled steel) by using a 150 micrometers (μm) applicator and dried firstly at 23 degrees Celsius (C) and relative humidity (RH) of 50% for 5 minutes (min), then at 60° C. for 30 min, and finally at 23° C. and 50% RH for 7 days. A scribe mark in the shape of an “X” was made by cutting through the dry film on the obtained coated panels using a razor blade. The edges of the coated panels were sealed with 3M vinyl electrical tape so that all uncoated regions and 5 min-width coatings film from each edge of the panels were covered by the tape. The regions covered by the tape is collectively referred as regions of uninterest.

Then these coated panels were put into a salt spray chamber Q-FOG SSP-600 from Q-Lab Corporation and exposed to a salt spray environment (5% sodium chloride fog) in accordance with ASTM B117-11. The salt spray chamber mimics corrosive environments. After a predefined number of hours, the panels were taken out from the salt spray chamber for evaluation by manual evaluation and automated evaluation below according to the present invention, respectively.

(A) Manual Evaluation: The coated panels were manually evaluated by three lab test operators through visual inspection. Degree of rusting reported as grade and distribution of rust was evaluated in accordance with ASTM D610-08. Degree of blistering reported as size and distribution of blisters was evaluated according to ASTM D714-02 (Reapproved 2009), respectively. Maximum one-side creepage in millimeter reported as “creepage width” was measured according to ASTM D16544-08.

(B) Automated Evaluation: The coated panels were automatically evaluated using the system of the present invention. An imaging unit comprising Keyence CV-X, CA-DRM10X ring light and CA-HX500M camera all available from Keyence Corp. was installed on the top of coated panel holders to acquire multi-angle and multispectral images for each coated panel. A computer deployed with the computational image processing unit, the corrosion detection unit, the data-preprocessing unit, and the data analysis unit of the present invention was connected to a Keyence controller in the imaging unit using an ethernet cable. This computer was used to control the imaging unit and to process the obtained grayscale images according to the inventive system to generate the corrosion resistance evaluation results automatically.

### Example 1

In order to verify the effectiveness and accuracy of the inventive system, white paint samples were used to compare the results from the manual evaluation and the automated evaluation according to the inventive system. A white paint formulation containing Binder 1 for forming white coated panel 1 is given in Table 2. OROTAN KUAI YI 731A dispersant, SURFYNOL TG, and TEGO Airex 902 W were mixed with water with stirring at a low speed to ensure all ingredients were well dispersed. Ti-Pure R-706 was added slowly and adjusted the rotation speed timely to keep the grind in a “doughnut” shape. After the fineness of the grinds was lower than 30 μm, water was further added and mixed evenly into the mixture. At the letdown stage, binder latex, water and aqueous ammonia were premixed, followed by adding the grind into the premix were gently added into the premix. After that, sodium nitrite (15%), Texanol, and ACRYSOL RM-8W thickener were added to give the paint formulation.

Other white paint formulations for preparing white coated panels 2 to 22 containing Binder 2 to Binder 22, respectively, are the same as the formulation for preparing Ex 1 used for preparing the white coated panel 1, except the binder type, the amount of the binder, and the amount of Texanol are as described below. The amount of each binder was adjusted based on solids content of the binder (% by weight) to ensure that the total solids for each paint formulation is equal. The amount of Texanol was adjusted based on the minimum film forming temperature (MFFT) in ° C. of the binder used, and can be calculated based on the equation below:

$$Amount of Texanol = Weight of binder \times solid content \times MFFT / 200$$

TABLE 2
White paint formulation for Example 1

| Material | Amount, gram |
|---|---|
| Grind | |
| Water | 42.00 |
| OROTAN ™ KUAI YI ™ 731A dispersant | 7.80 |
| SURFYNOL ™ TG | 1.00 |
| TEGO ™ Airex 902W | 0.46 |
| Ti-Pure R-706 | 209.24 |
| Water | 42.00 |
| Letdown | |
| Binder 1 (solids: 42%, MFFT: 27° C.) | 606.86 |
| Water | 198.43 |
| Aqueous ammonia (28%) | 4.00 |
| Sodium nitrite (15%) | 8.97 |
| Texanol | 34.41 |
| ACRYSOL ™ RM-8W thickener | 1.50 |

The obtained white paint formulations were used to prepare White Coated Panels 1 to 22, which were further characterized in accordance with the salt spray test described above.

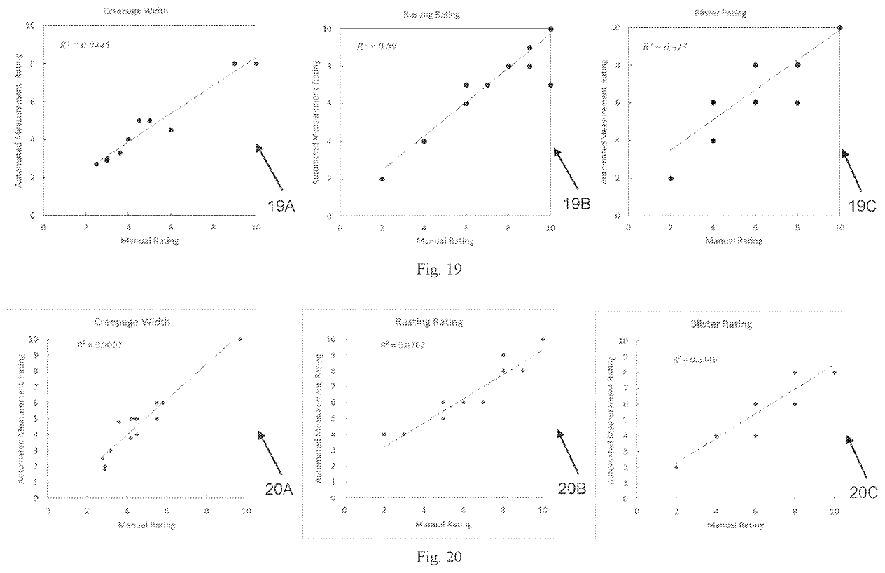

After the coated panels were taken out of the salt spray chamber, manual evaluation and automated evaluation were conducted on the coated panels, respectively. Three operators spent two minutes to observe and evaluate each sample, and the whole process for evaluation of ten samples from visual inspection to recording rating results took about 20 min. In contrast, it only took the system of the present invention about 10 seconds from image acquisition to automatic analysis for evaluation of each sample, and the whole process for evaluation of ten samples from image acquiring to results demonstration using the system of the present invention took up to two minutes. The inventive system demonstrates 10 times of improvement in the evaluation speed as compared to the manual evaluation process. Rating results of corrosion severity of these coated panels by manual evaluation by operators and automated evaluation using the inventive system are given in Table 3. Comparison of these ratings for some corrosion features is shown in FIG. 19. As shown in FIG. 19, the correlation results indicate regression coefficients are 94.45% for creepage width (19A), 89% for Rust Grade (19B), and 81.5% for Blister Size (19C). The results demonstrate that the novel automated system of the present invention can greatly improve the evaluation efficiency while providing the evaluation results close to the skilled lab operators, and also reduce potential bias and errors associated with manual inspection and evaluation by lab operators.

TABLE 3
Corrosion severity ratings of white paints by manual evaluation and automated evaluation

| White | Manual Evaluation | | | | | Automated Evaluation | | | | |
|---|---|---|---|---|---|---|---|---|---|---|
| coated | | Rusting Degree | | Blistering Degree | | | Rusting Degree | | Blistering Degree | |
| panel | Creepage | Rust | Rust | Blister | Blister | Creepage | Rust | Rust | Blister | Blister |
| No. | Width | Grade | Distribution | Size | Distribution | Width | Grade | Distribution | Size | Distribution |
| 1 | 4.5 | 10 | | 8 | M | 5.0 | 10 | | 8 | M |
| 2 | 10.0 | 10 | | 6 | F | 8.0 | 10 | | 8 | F |
| 3 | 3.0 | 7 | G | 10 | | 2.9 | 7 | G | 10 | |
| 4 | 9.0 | 9 | S | 8 | F | 8.0 | 9 | S | 8 | F |
| 5 | 3.0 | 10 | | 10 | | 3.0 | 10 | | 10 | |
| 6 | 4.0 | 10 | | 10 | | 4.0 | 10 | | 10 | |
| 7 | 2.5 | 10 | | 6 | F | 2.7 | 10 | | 6 | F |
| 8 | 4.0 | 10 | | 10 | | 4.0 | 10 | | 10 | |
| 9 | 3.0 | 10 | | | F | 3.0 | 10 | | | F |
| 10 | 6.0 | 10 | | 10 | | 4.5 | 10 | | 10 | |
| 11 | 5.0 | 10 | | 6 | F | 5.0 | 10 | | 6 | F |
| 12 | 5.0 | 10 | | 10 | | 5.0 | 10 | | 10 | |
| 13 | 3.6 | 10 | | 6 | | 3.3 | 10 | | 8 | |
| 14 | N.A. | 8 | | 6 | | N.A. | 8 | | 8 | |
| 15 | N.A. | 9 | | 4 | | N.A. | 8 | | 4 | |
| 16 | N.A. | 6 | | 4 | | N.A. | 7 | | 6 | |
| 17 | N.A. | 6 | | 4 | | N.A. | 6 | | 6 | |
| 18 | N.A. | 10 | | 4 | | N.A. | 7 | | 6 | |
| 19 | N.A. | 9 | | 6 | | N.A. | 8 | | 6 | |
| 20 | N.A. | 6 | | 8 | | N.A. | 7 | | 6 | |
| 21 | N.A. | 6 | | 8 | | N.A. | 6 | | 8 | |
| 22 | N.A. | 4 | | 2 | | N.A. | 4 | | 2 | |

N.A.—not tested

### Example 2

Gray paint formulations 1 to 15 containing Binder 1 to Binder 15, respectively, ere prepared in Example 2 to verify the robustness of the system of the present invention to evaluate coatings in colors other than white paints. Example 2 was conducted following the same procedure as Example 1, based on formulations given in Table 4. The obtained Gray Coated Panels 1 to 15 were characterized in accordance with the salt spray test described above. Rating results of corrosion severity of these coated panels by manual evaluation by operators and automated evaluation using the inventive system are given in Table 5. Comparison of these ratings for some corrosion features is shown in FIG. 20. As shown in FIG. 20, the correlation results indicate regression coefficients are 90.07% for creepage width (20A), 87.62% for Rust Grade (20B), and 83.46% for Blister Size (20C). The results demonstrate that the novel automated system of the present invention has the capability close to the ability of skilled lab operators in the ratings of corrosion features for gray paints.

TABLE 4
Gray paint formulation for Example 2

| Materials | Amount, gram |
|---|---|
| Grind | |
| Water | 40.00 |
| OROTAN ™ KUAI YI ™ 731A Dispersant | 7.25 |
| SURFYNOL ™ TG | 1.76 |
| TEGO ™ Airex 901W | 1.76 |
| BENTONE LT | 0.80 |
| PRINTEX ™ Powder-4 | 1.54 |
| Nubirox 106 | 52.78 |
| Barium sulfate | 92.36 |
| Ti-Pure R-706 | 80.04 |
| Water | 48.00 |
| Letdown | |
| Binder 2 (solid: 41.5%, MFFT: 38° C.) | 615.71 |
| Sodium nitrite (15%) | 8.97 |
| Texanol | 48.55 |
| ACRYSOL ™ RM-8W thickener | 1.50 |

TABLE 5
Corrosion severity ratings of gray paints by manual evaluation and automated evaluation

| Gray | Manual Evaluation | | | | | Automated Evaluation | | | | |
|---|---|---|---|---|---|---|---|---|---|---|
| coated | | Rusting Degree | | Blistering Degree | | | Rusting Degree | | Blistering Degree | |
| panel | Creepage | Rust | Rust | Blister | Blister | Creepage | Rust | Rust | Blister | Blister |
| No. | width | Grade | Distribution | Size | Distribution | width | Grade | Distribution | Size | Distribution |
| 1 | 4.2 | 8 | G | 8 | M | 3.8 | 8 | G | 8 | F |
| 2 | 9.7 | 8 | G | 4 | D | 10 | 9 | P | 4 | D |
| 3 | 5.8 | 7 | G | 6 | M | 6 | 6 | G | 4 | M |
| 4 | 3.6 | 10 | | 2 | | 4.8 | 10 | | 2 | D |
| 5 | 5.5 | 6 | P | 6 | M | 6 | 6 | G | 4 | M |
| 6 | 4.4 | 2 | P | 6 | | 5 | 4 | S | 6 | D |
| 7 | 4.5 | 10 | | 4 | | 4 | 10 | | 4 | D |
| 8 | 4.2 | 3 | P | 8 | F | 5 | 4 | S | 8 | D |
| 9 | 3.2 | 5 | P | 8 | D | 3 | 6 | P | 6 | D |
| 10 | 2.9 | 7 | P | 8 | F | 1.8 | 6 | P | 8 | F |
| 11 | 2.9 | 6 | G | 4 | F | 2 | 6 | G | 4 | F |
| 12 | 2.8 | 9 | P | 10 | | 2.5 | 8 | P | 8 | |
| 13 | 5.5 | 6 | G | 6 | F | 5 | 6 | G | 6 | F |
| 14 | 4.5 | 5 | P | 4 | F | 5 | 5 | P | 4 | F |
| 15 | 4.5 | 9 | P | 10 | | 5 | 8 | P | 8 | F |

1. A system for evaluation of anti-corrosion properties of a coating when applied on a corrosion susceptible substrate, comprising:
(i) an imaging unit configured to capture a plurality of grayscale images of the coating;
(ii) a computational image processing unit configured to receive and reconstruct the captured plurality of gray scale images and to output a reconstructed topographic image and a reconstructed color image;
(iii) a data preprocessing unit configured to receive and combine the reconstructed topographic image and the reconstructed color image and to output images containing high-dimensional data that comprises one-dimensional height data and at least three-dimensional color data;
(iv) a corrosion detection unit configured to receive the high-dimensional data and recognize corrosion features and to output at least locations, classifications, and regions of the corrosion features; wherein the corrosion detection unit comprises a corrosion detection neural network having an input layer and an output layer, wherein an input data to the input layer contains the high-dimensional data and an output data from the output layer contains at least locations, classifications, and regions of the corrosion features; and
(v) a computer-aided data analysis unit configured to receive and analyze the data containing at least locations, classifications, and regions of the corrosion features and to output predicted ratings of corrosion severity.

2. The system of claim 1, wherein the plurality of grayscale images of the coating comprise images acquired through multispectral illumination imaging and images acquired through multi-angle illumination imaging.

3. The system of claim 2, wherein the grayscale images acquired through multi-angle illumination imaging are reconstructed to the topographic image using surface height map information by a shape-from-shading algorithm.

4. The system of claim 2, wherein the grayscale images acquired through multispectral illumination imaging are reconstructed to the color image using a spectral reconstruction algorithm.

5. The system of claim 1, wherein the corrosion detection neural network is trained using a set of training coatings applied on a corrosion susceptible substrate by:
collecting a plurality of grayscale images of each training coating;
reconstructing the captured grayscale images for each training coating by computational processing and outputting a reconstructed topographic image and a reconstructed color image for each training coating;
combining the reconstructed topographic image and the reconstructed color image for each training coating and outputting images containing high-dimensional data for each training coating, comprising one-dimensional height data and at least three-dimensional color data;
obtaining at least actual locations, classifications, and regions of corrosion features for each training coating identified according to a quantified degree of rusting, degree of blistering, and maximum creepage;
creating a training dataset comprising a set of the high-dimensional data and a set of data containing the at least actual locations, classifications, and regions of corrosion features for the set of coatings; and
training the corrosion detection neural network using the training dataset.

6. The system of claim 1, wherein, before the corrosion detection neural network, the corrosion detection unit also comprises a region of interest neural network configured to recognize boundaries of regions of interest and to output the high dimensional data after the regions of interest extracted.

7. The system of claim 6, wherein the corrosion detection neural network and the region of interest neural network each independently use a U-Net neural network.

8. The system of claim 1, where, in the data preprocessing unit, the reconstructed color image is processed using the reflectance intensity of Red, Green and Blue spectral channels and converted to three-dimensional color data, and the topographic image is processed using grayscale values to represent surface height value and converted to one-dimensional height data.

9. The system of claim 1, wherein the at least three-dimensional color data and the one-dimensional height data are combined by matrices addition operation into the high-dimensional data.

10. The system of claim 1, wherein the computer-aided data analysis unit is also configured to quantify rating criteria of the corrosion features and to output predicted quantified ratings of corrosion severity.

11. The system of claim 1, wherein the predicted ratings of corrosion severity comprise degree of blistering, degree of rusting, creepage, and combinations thereof.

12. A computer-implemented method of evaluation of anti-corrosion properties of a coating when applied on a corrosion susceptible substrate, comprising:
receiving a plurality of grayscale images of the coating;
reconstructing the plurality of grayscale images by computational image processing and outputting a reconstructed topographic image and a reconstructed color image;
combining the reconstructed topographic image and the reconstructed color image into images containing high-dimensional data comprising one-dimensional height data and at least three-dimensional color data;
inputting the high-dimensional data to a corrosion detection unit configured to recognize corrosion features and to output at least locations, classifications, and regions of the corrosion features, wherein the corrosion detection unit comprises a corrosion detection neural network having an input layer receiving an input data and an output layer outputting an output data, wherein the input data contains the high-dimensional data and the output data contains at least locations, classifications, and regions of the corrosion features, and receiving and analyzing the data containing at least locations, classifications, and regions of the corrosion features and outputting predicted ratings of corrosion severity by computer-aided data analysis.

13. The computer-implemented method of claim 1, wherein the plurality of grayscale images are acquired through multispectral illumination imaging and multi-angle illumination imaging.

14. A computing device with a computational image processing unit, a data preprocessing unit, a corrosion detection unit, and a computer-aided data analysis unit, deployed thereon;
wherein the computational image processing unit is configured to receive and reconstruct the captured plurality of grayscale images and to output a reconstructed topographic image and a reconstructed color image;
wherein the data preprocessing unit is configured to receive and combine the reconstructed topographic image and the reconstructed color image and to output images containing high-dimensional data that comprises one-dimensional height data and at least three-dimensional color data;
wherein the corrosion detection unit is configured to receive the high-dimensional data and recognize corrosion features and to output at least locations, classifications, and regions of the corrosion features: wherein the corrosion detection unit comprises a corrosion detection neural network having an input layer and an output layer, wherein an input data to the input layer contains the high-dimensional data and an output data from the output layer contains at least locations, classifications, and regions of the corrosion features; and
wherein the computer-aided data analysis unit is configured to receive and analyze the data containing at least locations, classifications, and regions of the corrosion features and to output predicted ratings of corrosion severity.

15. A process for training a neural network for detection corrosion, comprising:
collecting a plurality of grayscale images of a set of coatings when applied on a corrosion susceptible substrate;
reconstructing the captured grayscale images for each coating by computational processing and outputting a reconstructed topographic image and a reconstructed color image for each coating;
combining the reconstructed topographic image and the reconstructed color image for each coating and outputting images containing high-dimensional data for each coating, comprising one-dimensional height data and at least three-dimensional color data;
obtaining at least actual locations, classifications, and regions of corrosion features for each coating identified according to a quantified degree of rusting, degree of blistering, and maximum creepage;
creating a training dataset comprising a set of the high-dimensional data and a set of data containing the at least actual locations, classifications, and regions of corrosion features for the set of coatings; and
training the neural network using the training dataset; thereby obtaining the trained neural network.
